(19) United States
(12) Patent Application Publication
(10) Pub. No.: US 2014/0239118 A1
(43) Pub. Date: Aug. 28, 2014

(54) Method and Apparatus for Foldable Wing UAV

(71) Applicant: Itzhak Sapir, Irvine, CA (US)

(72) Inventor: Itzhak Sapir, Irvine, CA (US)

(21) Appl. No.: 13/774,157

(22) Filed: Feb. 22, 2013

(51) Int. Cl. B64C 39/02; B64F 1/10

(52) U.S. Cl. CPC B64C 39/024; B64C 39/028; B64F 1/10
USPC 244/49

(57) ABSTRACT

A device for releaseably retaining a wing of an aerial vehicle in a folded orientation in a bore of a tube is disclosed. A retaining element is bound around the folded wing elements of a foldable-winged UAV so that the maximum diameter of the folded and bound UAV is less than the diameter of the bore. A releasable retaining fastener is provided and configured whereby the fastener releases when the UAV is propelled through and exits the bore, releasing the retaining element after which the wings of the UAV unfold and return to a flight orientation. The retaining element may include a tether for the retention and reuse of the device after a launch.

### CROSS-REFERENCE TO RELATED APPLICATIONS

This application claims the benefit of U.S. Provisional Patent Application No. 61/602,115 entitled “Method and Apparatus for Foldable Wing UAV”, filed on Feb. 23, 2012, the entirety of which is incorporated herein by reference and to which priority is claimed pursuant to 35 USC 119.

### STATEMENT REGARDING FEDERALLY SPONSORED RESEARCH AND DEVELOPMENT

N/A

### BACKGROUND OF THE INVENTION

1. Field of the Invention

The invention relates generally to the field of launch devices and methods for micro-unmanned aerial vehicles or “UAVs”.

More specifically, the invention relates to an apparatus and method for launching a micro-UAV having a foldable or deformable wing structure from a tube or bore of an existing weapons system such as a TOW missile tube.

2. Background of the Invention

Current military surveillance and reconnaissance efforts rely heavily on unmanned aerial vehicles and unmanned aerial systems (i.e., UAVs and UASs respectively) for a variety of missions. Such missions include threat identification and assessment, identifying locations of enemy combatants and enemy materiel, damage analysis, rescue and mapping and coordinating military operations in unfamiliar territory.

Current aerial vehicle launch systems typically require that the UAS operator physically enter the combat environment to launch the UAV, thus exposing the operator to enemy fire, toxic substances, blast injury or other combat threats.

It is desirable for a user to launch a small (usually less than five pounds and a wing span of less than four feet) UAV or UAS from the safety of a mobile vehicle such as the armored personnel compartment of a combat vehicle without the need of exposing the operator to enemy fire.

To address the above need, an unmanned aerial surveillance and reconnaissance launch system is disclosed in U.S. Pub. No. US 2011/0168838, “Launch Tube Deployable Surveillance and Reconnaissance System”, dated Jul. 14, 2011, which application is fully incorporated herein by reference and is commonly assigned to ISC8 Inc., the assignee herein.

The above cited reference discloses an unmanned aerial vehicle that is launchable from, for instance, the bore of an existing weapons system mounted on a mobile vehicle such as the weapon barrel of a tank or armored combat vehicle and which launch may be remotely initiated from the protected armored compartment of the mobile vehicle.

The wings of the unmanned aerial vehicle in the above cited reference are selectively foldable and deformable whereby the wings are foldable from an outwardly projecting orientation to a folded orientation so as to allow the unmanned aerial vehicle to be disposed within the bore of a tube such as the weapon bore of a tank or armored combat vehicle for launching.

Propulsion means is disclosed in the above-cited application that is disposed within the bore for the propulsion of the aerial vehicle longitudinally along the length of the bore and out of the muzzle into the operating environment. The initiation of the launch of the aerial vehicle desirably occurs from within the enclosed armored compartment of the vehicle where the operator is not exposed to combat threats such as small arms fire.

Unfortunately, the friction during launch that occurs as a result of the outward urging of the folded flexible wing elements in contact with the interior bore surface requires undue propulsion energy and negatively affects the launch process.

What is needed is a device that temporarily retains the folded wing elements of the aerial vehicle in a circumference that is less than that of the interior bore diameter to permit the relatively unrestricted travel of the aerial vehicle within the bore length in a launch but that releases the wing elements to permit their expansion to flight mode after the vehicle exits the muzzle.

### SUMMARY OF THE INVENTION

In a first aspect of the invention, a device for releaseably retaining a foldable wing element of an aerial vehicle in a bore is provided comprising a flexible retaining element comprising a first end portion and a second end portion that is configured for retaining a foldable wing element of an aerial vehicle in a folded orientation in a bore.

The first end portion comprises a releasable fastening element comprising an inwardly depending lip element and the second end portion comprises a receiving aperture configured for receiving the lip element when the retaining element is disposed and bound about a circumference of the aerial vehicle in the folded orientation.

The second end portion is configured whereby the lip element is retained in the receiving aperture by an inner surface of the bore when in a folded orientation and the second element is configured whereby the lip element is released from the receiving aperture as a result of a spring force of the wing element when the aerial vehicle exits the bore.

In a second aspect of the invention, the retaining element is configured wherein the circumference of the aerial vehicle, when in the folded orientation, is less than an inner diameter of the bore.

In a third aspect of the invention, the retaining element further comprises a tether element fixedly connected to a user-defined element which may be any structure or element selected by a user including but not limited to a structural element on the exterior of the weapon tube or vehicle from which the UAV is launched

In a fourth aspect of the invention, a launch tube deployable surveillance and reconnaissance system is provided comprising a launch tube comprising a barrel wherein the barrel further comprises a bore having a longitudinal axis and a muzzle aperture.

This aspect of the invention may further comprise an aerial vehicle comprising at least one flexible and foldable wing element that is adaptable to be received within the bore and comprises a flexible retaining element comprising a first end portion and a second end portion that is configured for retaining the wing element in a folded orientation in the bore whereby the circumference of the aerial vehicle is less than an inner diameter of the bore.

The first end portion comprises a releasable fastening element comprising an inwardly depending lip element and the second end portion comprises a receiving aperture configured for receiving the lip element when the retaining element is disposed about the circumference of the aerial vehicle in the folded orientation.

The second end portion is configured whereby the lip element is retained in the receiving aperture by an inner surface of the bore when in the folded orientation. The second element is configured whereby the lip element is released from the receiving aperture as a result of a spring force of the wing element when the aerial vehicle exits and is unrestrained by the bore surface.

These and various additional aspects, embodiments and advantages of the present invention will become immediately apparent to those of ordinary skill in the art upon review of the Detailed Description and any claims to follow.

While the claimed apparatus and method herein has or will be described for the sake of grammatical fluidity with functional explanations, it is to be understood that the claims, unless expressly formulated under 35 USC 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 USC 112, are to be accorded full statutory equivalents under 35 USC 112.

### BRIEF DESCRIPTION OF THE DRAWINGS

FIG. 1 is a view of the flexible retaining element and tether element of the invention immediately after a UAV exits the bore of a tube.

FIG. 2 is a view of a UAV having its flexible wings in a folded orientation and retained by the retaining element of the invention in the bore of a tube.

FIG. 3 is a front view of the UAV in the bore of a tube of FIG. 2.

FIG. 4 is a view of the UAV of FIG. 1 having exited the bore of the tube and its flexible wings unfolded to a flight orientation with the retaining element released and tethered by the tether of the invention.

The invention and its various embodiments can now be better understood by turning to the following detailed description of the preferred embodiments which are presented as illustrated examples of the invention defined in the claims. It is expressly understood that the invention as defined by the claims may be broader than the illustrated embodiments described below.

### DETAILED DESCRIPTION OF THE INVENTION

Applicant discloses herein a method and apparatus for launching a UAV having a foldable or deformable wing structure such as is available, for instance, from Applied Research Associates, Inc., from a tube or the bore of an existing weapon system. An exemplar weapon system may comprise a TOW missile tube.

The foldable wing structure of the UAV may be fabricated from a flexible, carbon fiber material so as to permit the wing elements to be temporarily folded about the fuselage of the UAV in a retained or bound orientation but when unrestrained or unbound, spring back to a flight orientation due to the resilient, flat spring-like nature of the wing and its carbon fiber material.

When a foldable wing UAV is launched from a tube or weapon bore, its foldable wing structure (e.g., carbon fiber) is typically folded by a user around the fuselage of the UAV and returns to a flight position upon exiting the bore using the wings' spring-like material and design. Unfortunately, when traveling inside the bore of the tube during a launch event, significant friction occurs due to the wings' spring force urging the wing surfaces against the interior surface of the diameter of the bore.

The resultant wing/interior bore surface friction reduces launch speed and may even disrupt the launching operation. In addition, the launch mechanisms used to propel a UAV from the bore are required to overcome this friction resistance by applying higher force on the UAV; thus increasing the risk of damaging the UAV, the launch mechanism or both.

Prior attempts by the Applicant herein to solve the above launch problem have included increasing the smoothness of the tube interior surface and by reducing wing stiffness. Undesirably, the reduced wing stiffness approach reduces the chance of a successful wing deployment after the UAV leaves the bore and an increased bore interior smoothness does not substantially increase launch performance.

The wing pre-fold retaining device of the invention desirably provides minimal surface contact and related friction of the UAV wing surfaces with the bore interior surface in a launch from the bore of a tube. Using the retaining element invention, there is virtually no spring force resulting from the urging of the wing surfaces against the bore surface whereby interior bore friction is greatly minimized. Using the device of the invention, the diameter of the pre-folded wing and fuselage is maintained and provided so as to be less than the bore's interior diameter.

No such solution is known to be used in the prior art.

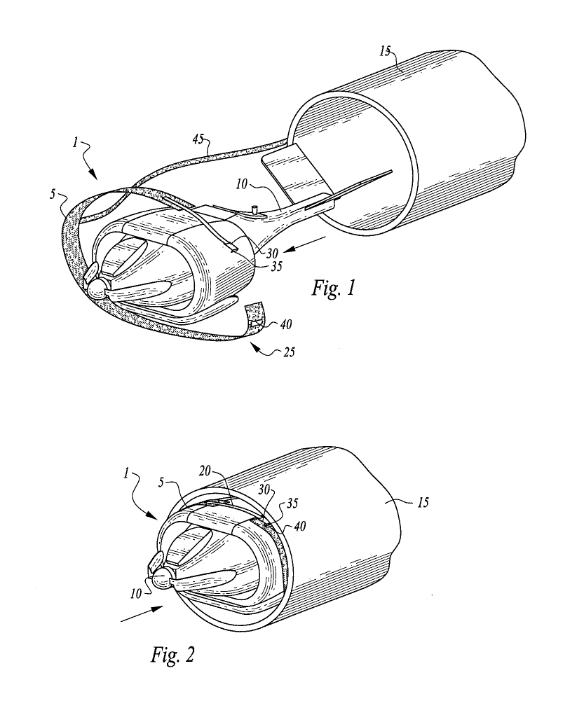

Turning now to the figures wherein like numerals denote like elements among the several views and specifically with respect to FIGS. 1 and 4, device 1 of the invention is generally comprised of a belt or strap-like flexible retaining element 5.

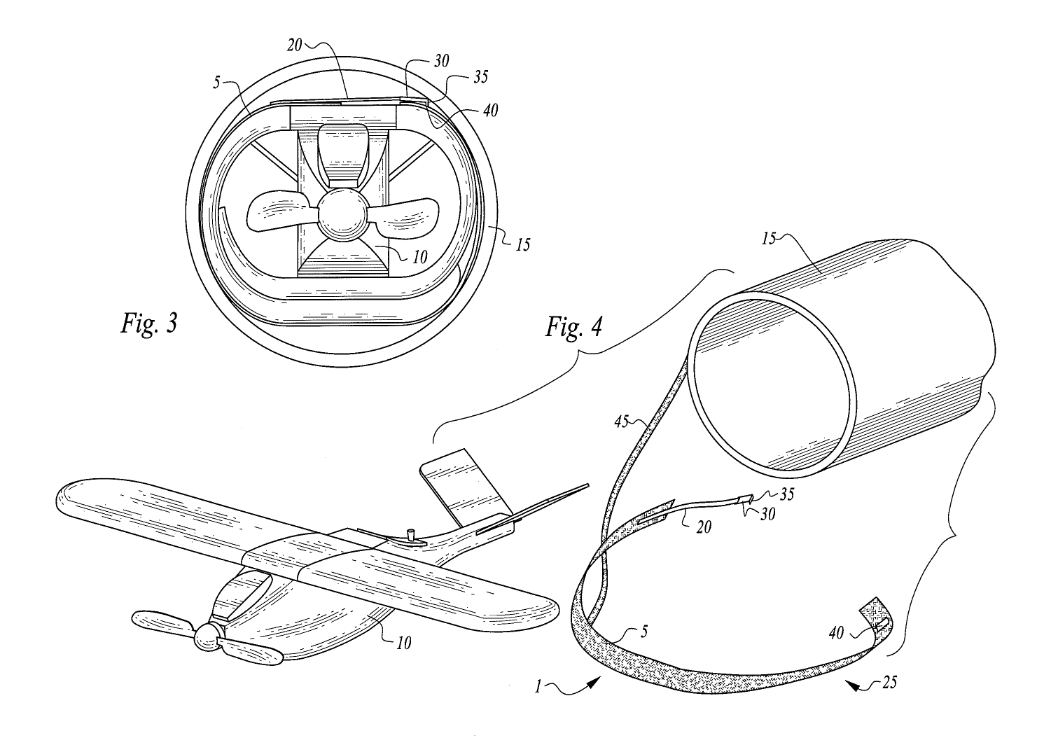

The material for retaining element 5 may be any material suitable for binding the folded wings of a foldable wing UAV 10 about its fuselage whereby the bound UAV may be received in the bore of a tube 15 as best illustrated in FIG. 2 and FIG. 3.

Exemplar materials from which retaining element 5 may be fabricated may comprise a nylon or polyester webbing or strap or equivalent material of sufficient strength and durability to withstand the outward spring forces and urging of the folded wings of a UAV when in a folded orientation.

Device 1 comprises a first end portion 20 and a second end portion 25. Retaining element 5 preferably defines a strap, belt or a circumferential binding element configured so as to define a maximum retained diameter of UAV 10 that is less than the minimum tube 15 internal diameter.

Retaining element 5 is configured for retaining a foldable wing element of an aerial vehicle 10 in a folded orientation as best illustrated in FIGS. 3 and 5.

First end portion 20 comprises a releasable fastening element 30 which, in turn, defines an inwardly depending lip element 35

Second end portion 25 comprises a receiving aperture 40 configured for releaseably retaining lip element 35 when retaining element 5 is bound around the folded wings of a UAV. In this orientation, retaining element 5 is in tension due to the outward spring force and urging of the retained flexible wing elements.

As better seen in FIG. 2 and FIG. 3, lip element 35 of fastening element 30 is retained within receiving aperture 40 by the interior surface of the bore of the tube 15 when the UAV around which it is bound is inserted in the bore of the tube.

As better seen in FIG. 4, after UAV 10 exits the bore of tube 15, fastening element 30 is no longer in contact with the interior surface of the bore of tube 15 and the outward spring force urging of the flexible wing elements of UAV 10 releases lip element 35 from receiving aperture 40 whereby retaining element 5 is released and “opens” from receiving aperture 40 and releases retaining element 5 from the circumference of UAV 10.

Retaining element 5 is preferably configured so that when it is bound around the circumference of the UAV 10 in a folded configuration, the maximum diameter of the bound UAV is less than that of the minimum interior diameter of the bore.

With respect to FIG. 4, after UAV 10 exits the bore of tube 15 and the wing elements unfold to a flight orientation as illustrated, a tether element 45 may be provided to secure and retain retaining element 5 after a launch for reuse. Tether element 45 is desirably secured to any user-defined structure, preferably, an exterior element of tube 15 or the vehicle or structure upon which it is mounted.

The result of using this approach is minimal friction between the UAV and the tube inner surface during a launch event.

Many alterations and modifications may be made by those having ordinary skill in the art without departing from the spirit and scope of the invention. Therefore, it must be understood that the illustrated embodiment has been set forth only for the purposes of example and that it should not be taken as limiting the invention as defined by the following claims. For example, notwithstanding the fact that the elements of a claim are set forth below in a certain combination, it must be expressly understood that the invention includes other combinations of fewer, more or different elements, which are disclosed in above even when not initially claimed in such combinations.

The words used in this specification to describe the invention and its various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what essentially incorporates the essential idea of the invention.

I claim:

1. A device for releaseably retaining a wing of an aerial vehicle in a folded orientation in a bore of a tube comprising:
a flexible retaining element comprising a first end portion and a second end portion configured for retaining a foldable wing element of an aerial vehicle in a folded orientation in a bore,
the first end portion comprising a releasable fastening element comprising an inwardly depending lip element,
the second end portion comprising a receiving aperture configured for receiving the lip element when the retaining element is disposed about a circumference of the aerial vehicle in the folded orientation,
the second end portion configured whereby the lip element is retained in the receiving aperture by an inner surface of the bore when in the folded orientation, and,
the second element configured whereby the lip element is released from the receiving aperture as a result of a spring force of the wing element when the aerial vehicle exits the bore.

2. The device of claim 1 wherein the retaining element is configured whereby the circumference of the aerial vehicle in the first folded orientation is less than a minimum inner diameter of the bore.

3. The device of claim 1 wherein the retaining element further comprises a tether element fixedly connected to a user-defined element.

4. A launch tube deployable surveillance and reconnaissance system comprising:
a launch tube comprising a barrel of a weapon system,
the barrel further comprising a bore having a longitudinal axis and a muzzle aperture,
an aerial vehicle comprising at least one flexible and foldable wing element adaptable to be received within the bore,
a flexible retaining element comprising a first end portion and a second end portion configured for retaining the wing element in a folded orientation in the bore whereby the circumference of the aerial vehicle is less than a minimum inner diameter of the bore,
the first end portion comprising a releasable fastening element comprising an inwardly depending lip element,
the second end portion comprising a receiving aperture configured for receiving the lip element when the retaining element is disposed about the circumference of the aerial vehicle in the folded orientation,
the second end portion configured whereby the lip element is retained in the receiving aperture by an inner surface of the bore when in the folded orientation, and,
the second element configured whereby the lip element is released from the receiving aperture as a result of a spring force of the wing element when the aerial vehicle exits the bore.

5. The device of claim 4 wherein the retaining element is configured whereby the circumference of the aerial vehicle in the folded orientation is less than a minimum inner diameter of the bore.

6. The device of claim 4 wherein the retaining element further comprises a tether element fixedly connected to a user-defined element.
